(19) United States
(12) Patent Application Publication
(10) Pub. No.: US 2025/0229656 A1
(43) Pub. Date: Jul. 17, 2025

(54) VEHICLE CHARGING SYSTEM

(71) Applicant: Janice M. Rifkin, Ballwin, MO (US)

(72) Inventor: Janice M. Rifkin, Ballwin, MO (US)

(21) Appl. No.: 19/019,367

(22) Filed: Jan. 13, 2025

Related U.S. Application Data
(60) Provisional application No. 63/620,612, filed on Jan. 12, 2024.

(51) Int. Cl. B60L 53/14; B60B 19/00; B60C 19/08; B60L 53/10

(52) U.S. Cl. CPC B60L 53/14; B60B 19/00; B60L 53/11; B60C 19/082

(57) ABSTRACT

An electric vehicle charging system for use with an electric vehicle having a charging system including two spaced wheels capable of conducting electricity to a rechargeable battery. The vehicle charging system includes a DC power supply, an insulating base, and a plurality of conductive charging pads mounted on the base. A first and a second charging pad are electrically connected to the first and second terminals, respectively. The first and second charging pads are positioned to allow one spaced wheel to electrically communicate with the first pad while a second spaced wheel electrically communicates with the second pad. The first terminal of the power supply is connected to the battery via the first pad and the first wheel and the second terminal is connected to the battery via the second pad and second wheel.

### CROSS-REFERENCE TO RELATED APPLICATION

This application claims the benefit of U.S. Provisional Patent Application No. 63/620,612 filed on Jan. 12, 2024, which is hereby incorporated by reference in its entirety.

### BACKGROUND

The present disclosure is directed to vehicle charging systems, and more particularly, to cordless charging systems for charging vehicles when stationary and cordless charging systems for charging vehicles when moving.

Electric vehicles have many advantages over vehicles powered by internal combustion engines, including having lower fuel and maintenance costs. However, fueling stations for electric vehicles (i.e., charging stations) are currently less common than traditional gas and diesel fueling stations. In addition, at present charging electric vehicles takes longer than filling fuel tanks of internal combustion engine vehicles. These factors make traveling longer distances in electric vehicles more burdensome than in internal combustion engine vehicles and dissuade some consumers from buying electric vehicles. Thus, there is a need to provide additional opportunities to charge electric vehicles, particularly opportunities to charge vehicles without lengthy stops.

Electrical vehicle charging stations are less common in more remote areas. Smart phone applications have been created to direct electrical vehicle users to charging stations available within remaining cruising range. These applications are rendered useless, however, when a user arrives at the charging station to find it inoperable. Although the inoperability may result from power grid outages or charging station failures, the stations are more often inoperable because vandals have damaged the charging cable or connector. If other chargers are out of range, users can be stranded in remote locations until the station is repaired or their vehicle can be charged using other means. Thus, there is a need for charging stations that connect to vehicles without cables and connectors, so they are less susceptible to compatibility issues, vandalism, wear, and other damage.

### SUMMARY

In one aspect, this disclosure includes an electric vehicle charging system for use with an electric vehicle having a frame mounted on a plurality of wheels. At least one wheel of the plurality of wheels is driven by an electrical motor mounted on the frame powered by a rechargeable battery mounted on the frame. The vehicle also has a charging system including two spaced wheels of the plurality of wheels capable of conducting electricity to the rechargeable battery for charging. The vehicle charging system comprises a selectively operable managed DC power supply having a first terminal and a second terminal. The first terminal has a positive electrical charge relative to the second terminal when the managed DC power supply is operated. The vehicle charging system also includes an electrically insulating base sized to support the two spaced wheels simultaneously. Additionally, the charging system comprises a plurality of electrically conductive charging pads mounted on the electrically insulating base. A first electrically conductive charging pad of the plurality of electrically conductive charging pads is electrically connected to the first terminal of the managed DC power supply and a second electrically conductive charging pad of the plurality of electrically conductive charging pads is electrically connected to the second terminal of the managed DC power supply. The first electrically conductive charging pad and the second electrically conductive charging pad are positioned on the electrically insulating base to allow a first wheel of the two spaced wheels to be in electrical communication with the first electrically conductive charging pad while a second wheel of the two spaced wheels is in electrical communication with the first electrically conductive charging pad. Thus, the first terminal of the managed DC power supply to the rechargeable battery via the first electrically conductive charging pad and the first wheel of the two spaced wheels and the second terminal of the managed DC power supply to the rechargeable battery via the second electrically conductive charging pad and the second wheel of the two spaced wheels to charge the rechargeable battery in the electric vehicle.

In another aspect, this disclosure includes an electric vehicle for use with a charging system adapted to deliver DC power to spaced charging pads. The vehicle comprises a vehicle frame and a rechargeable battery mounted on the vehicle frame. The vehicle also includes an electric motor mounted on the vehicle frame and operatively connected to the rechargeable battery to power the electric motor. A plurality of wheels is rotatably mounted on the vehicle frame. At least one wheel is operatively connected to the electric motor for rotating the wheel to move the electric vehicle. At least two wheels are in electrical communication with the rechargeable battery. The one wheel of the two wheels is positionable on one charging pad of the charging system while a second wheel of the plurality of wheels is positioned on a second charging pad of the charging system.

Other aspects of the present disclosure will be apparent in view of the following description and claims.

### BRIEF DESCRIPTION OF DRAWINGS

The present disclosure includes non-limiting examples illustrated in the accompanying drawings.

FIG. 1 is a fragmentary schematic plan of a system of a first example of the present disclosure;

FIG. 2 is a schematic cross section of one example of a tire and rim for use in the system;

FIG. 3 is a fragmentary schematic plan of a system of a second example of the present disclosure;

FIGS. 4A-4C are schematic elevations taken in the plane of line 4-4 of FIG. 3;

FIG. 5 is a fragmentary schematic plan of a system of a third example of the present disclosure.

Corresponding reference characters indicate corresponding parts throughout the drawings.

### DETAILED DESCRIPTION

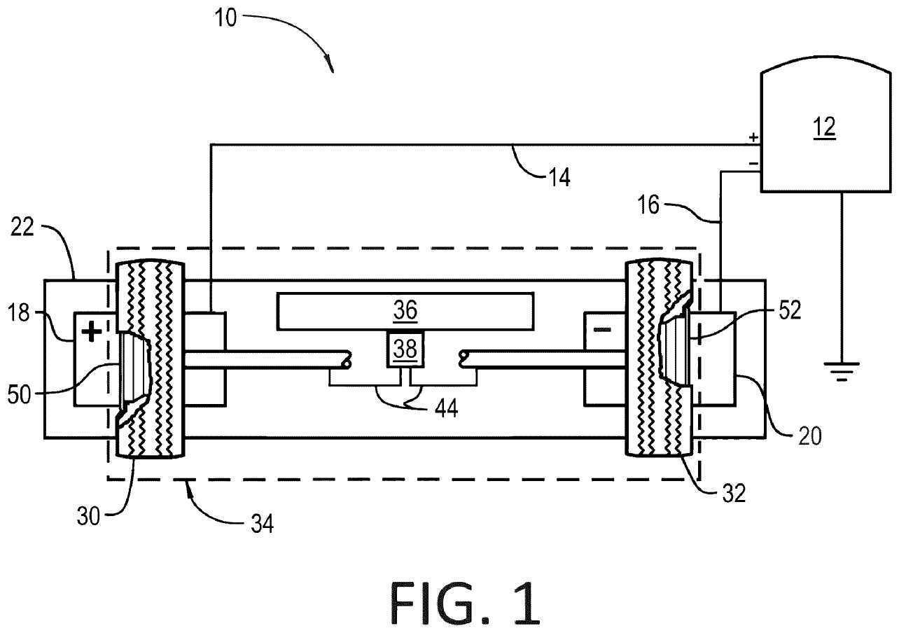

As shown in FIG. 1, a first example of a charging system described herein is designated in its entirety by the reference character 10. The charging system 10 of the first example is a “stationary mode” system for use when the electric vehicle is stationary such as when the vehicle is parked in a garage, a driveway, or another parking spot. The system 10 comprises a managed direct current (“DC”) power supply, generally designated by 12, powered by a conventional electrical power grid or other power source (not shown). The illustrated power supply 12 is configured to deliver high current, low voltage power (e.g., 40 volts nominal) but it is envisioned that the power supply may be configured to deliver other voltages. It is anticipated that in most cases a lower voltage (e.g., 40 volts or less) will be preferred to reduce or eliminate a possibility of users encountering a lethal electrical shock, but higher voltages may be necessary if, for example, the charging circuit has excessive electrical resistance. It is believed that raising the charge voltage much above 40 volts DC would increase risk. Electrical leads 14, 16 operatively connect the power supply 12 to spaced, electrically conductive, corrosion resistant surfaces or charging pads 18, 20, respectively, mounted on an electrically insulated base 22. In the illustrated example, the charging pads 18, 20 comprise a metal and the base 22 comprises a rubber pad on which the pads 18, 20 are mounted, but it is envisioned that other suitable materials may be used. In one example, the charging pads 18, 20 comprise a metal in combination with another material. Further, the illustrated base 22 has a thickness of about 0.5 inches, but other electrically insulating materials having other dimensions may be used. The illustrated example shows the driver-side charging pad 18 operatively connected to a positive terminal of the power supply 12 to provide a positive charge, and the passenger-side charging pad 20 operatively connected to the negative terminal of the power supply 12 to provide a negative charge. The charging pads 18, 20 are configurated to receive spaced wheels, generally designated by 30, 32, of an electric vehicle, generally designated by 34. Accordingly, the charging pads 18, 20 are spaced to simultaneously receive laterally spaced wheels of a vehicle 34 having a predetermined track width. The electric vehicle 34 includes a multiple-cell, rechargeable battery pack 36 controlled by a conventional battery management system 38 for optimizing battery pack operation including recharging.

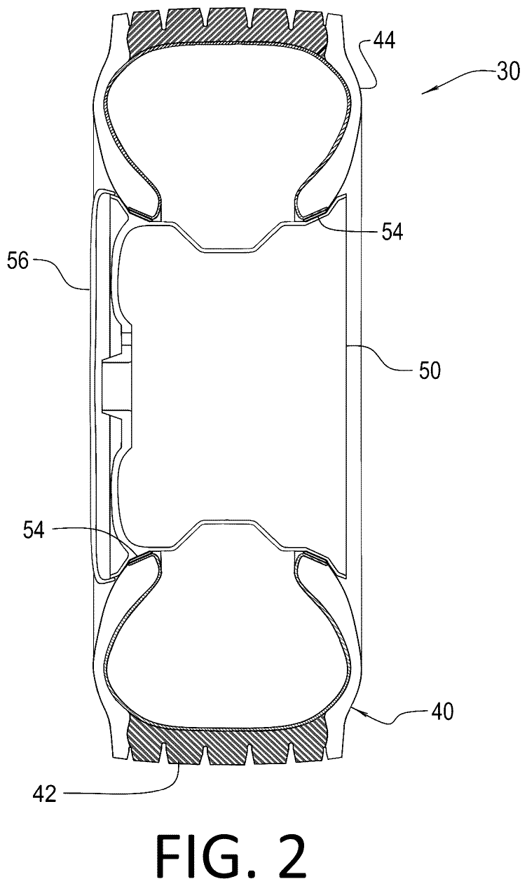

FIG. 2 illustrates one example of a conductive wheel 30 comprising an electrically conductive tire, generally designated by 40. The opposite conductive wheel 32 (not shown) is identical to the example shown in FIG. 2. The tire 40 includes an electrically conductive tread portion 42 bridging opposing sidewalls 44. Although the tread 42 may comprise other materials without departing from the intended scope of this description, the illustrated tire 40 comprises a modified rubber compound including conductive materials (i.e., multicon tires). The conductive materials may comprise modified rubber compounds including a combination of conductive metal wires, metal braids, metal fabric, metal particles, metal powders, metal flakes, conductive elastomers, conductive polymers, carbon black, nanocarbon, nanotubes, silicone and carbon mixtures, graphite, graphene, silicone infused with silver or aluminum alloys, nanocarbon black, and/or other combinations. Additional materials may be used to improve wear resistance, durability, strength, and electrical conductivity of the tire. Broadly, the tire 40 has internal metallic components 46 such as a belt or a braided wire wrapped in a conductive rubber mixture. This construction provides tires usable on roadways and minimizes electric resistance to allow electrical current to pass efficiently. Although the sidewalls 44 of the illustrated tire 40 is formed from an electrically insulated material, in some examples the sidewalls of the tire include a thin electrically insulating layer to reduce opportunity for users to make contact with energized surfaces. The internal metal braid or conductive materials and rubber mixture carry current to electrically conductive rims 50, 52, respectively. In some examples, it is envisioned that an electrically conductive sealant 54 may be used to mount the tires 30, 32 on the rims 50, 52 to improve conductivity between the components. The rims 50, 52 are electrically connected to the battery management system 38 in the vehicle 34 via conventional electrical conductors (not shown). As will be appreciated, the conventional conductors may include stationary conductors such as wires, cables, bundles, and wire harnesses, as well as rotary electrical power transmission devices such as electrical brushes, conductive bearings, and slip rings. Electrical power supplied to the charging pads 18, 20 passes through the tires 30, 32, the corresponding rims 50, 52, and electrical conductors to the battery management system 38 for recharging the battery pack 36 in the vehicle 34. An electrically insulated cover 56 is mounted over the exposed rim 50 to prevent users from contacting electrically charged rim. Because the driver-side tire 30 of the illustrated example has a positive charge and the passenger-side tire 32 has a negative charge, the vehicle components (i.e., the conductors 44) connected to the driver-side tire must be electrically insulated from the components connected to the passenger-side tire. The charging pad can be constructed out of any conductive materials without departing from the intended scope of this description.

As used in this disclosure “electric vehicle” is intended to include all suitable electrically dockable vehicles (e.g., an electrically powered land vehicles, as well as aeronautical vehicles such as drones). Thus, in addition to a four-wheel automobile, the electrical vehicle might include an electrically powered trike. Further, the charger is scalable to vehicles having more than four wheels. For example, an 18-wheel electric truck could be engineered to accept power from the charger and function similarly.

As will be appreciated, vehicle weight presses the tires 30, 32 against the charging pads 18, 20, respectively, enhancing electrical connection between the charging pads and the electrically conductive tires provided the contacting surfaces of the tires and pads are generally free from nonconductive dirt and debris. The vehicle weight improves electrical “coupling” between the vehicle tires 30, 32 and the charging pads 18, 20 lowering electrical resistance and increasing current flow between the tires and charging pads. Although increasing the tire diameter and width increases the contact area between the tire and the charging pad, the “coupling” pressure between the tire and charging pad decreases with increased tire diameter and width. Tread gaps also decrease the effective contact area or “coupling” footprint. Those skilled in the art will appreciate that these competing factors should be considered when determining tire size. The area of contact or “coupling” footprint of a 245/45 R18 conductive tire is about 6 inches by about 8 inches or 48 square inches of contact between the tire and the energized surface. Although “coupling” footprint lengths can be increased using larger diameter tires inflated to lower tire pressures, it is envisioned that the characteristics of known street acceptable conductive rubber may limit coupling footprint lengths to less than one foot, and not limited to one foot in distance. The remaining high current path is made of conventional rigid, semi-rigid or flexible metallic conductors having a low electrical and thermal resistance. Those skilled in the electrical arts should appreciate the benefits.

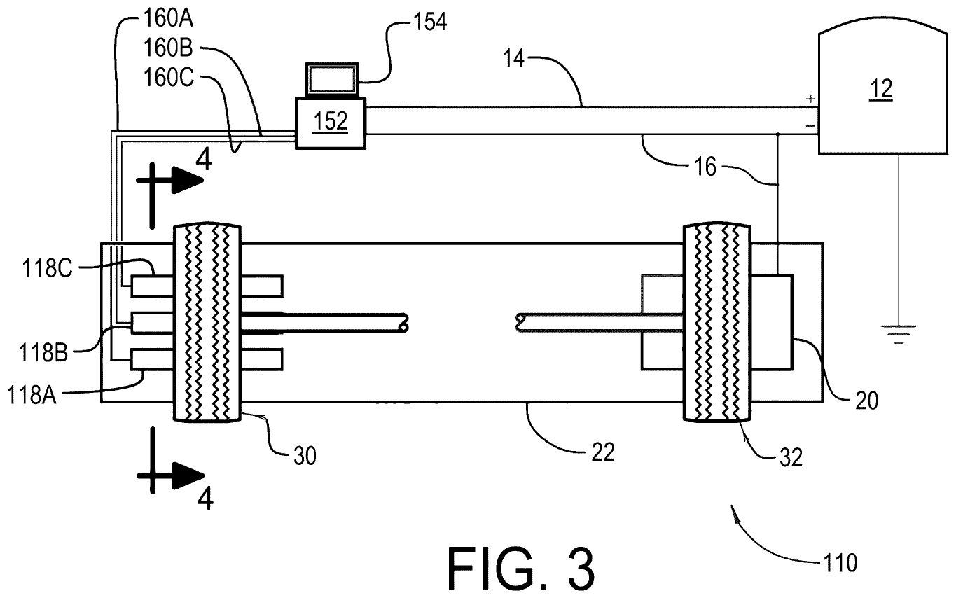

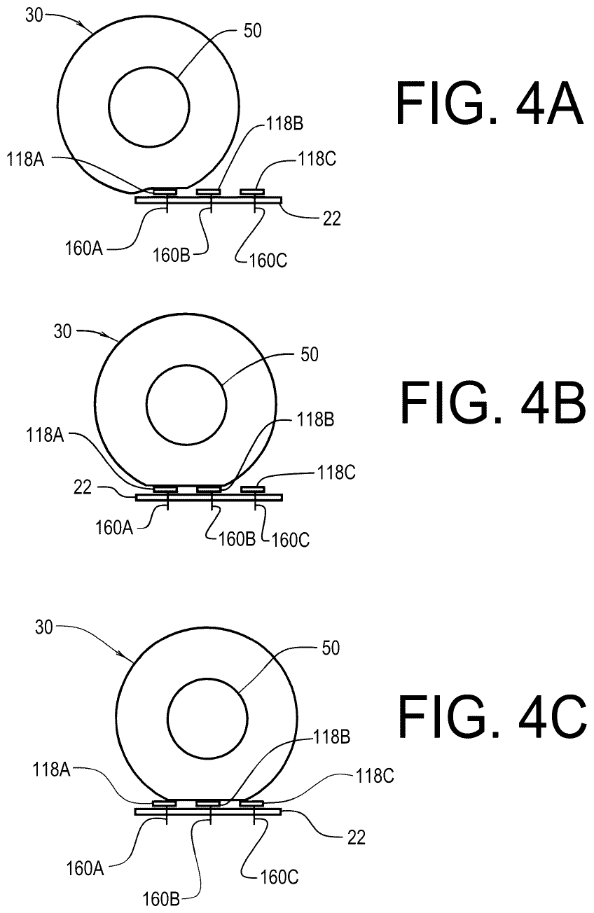

FIG. 3 illustrates a second example of a charging system, generally designated by 110, that ensures an electric vehicle 34 is properly aligned with the charging pads for charging. It should be understood that the electric vehicle 34 of the second example is identical to the electric vehicle illustrated in FIG. 1. Elements such as recharging the battery pack 36, the battery management system 38, and the electrical conductors 44 are omitted from FIG. 3 to reduce drawings complexity. Further, the addition of a “1” in the hundreds place of some elements (e.g., system 110) indicates the element is structurally different than the corresponding element (e.g., system 10) in the first example is identical to the electric vehicle illustrated in FIG. 1. Elements such as the battery pack 36, the battery management system 38, and the electrical conductors 44 are omitted from FIG. 3 to reduce drawing complexity. Further, the addition of a “1” in the hundreds place of some elements (e.g., system 110) indicates the element is structurally different than the corresponding element (e.g., system 10) in the first example. The charging system 110 is similar to the charging system 10 of the first example except that the positively charged, driver-side charging pad 18 of the first charging system 10 is replaced with a series of narrower, separated charging pads 118A-118C. Each of the charging pads 118A-118C is connected to the power supply 12 via a separate sensing conductor 160A-160C, respectively, and a position indicator module 162. This arrangement permits the charging system 110 to determine whether the vehicle tires 30, 32 are properly located for charging. As shown in FIG. 4C, tire 30 is properly located for charging when the tire 30 simultaneously contacts a rearward charging pad 118A, a central charging pad 118B, and a forward charging pad 118C. As will be appreciated, in an alternative example, the tire 30 might only contact the central charging pad 118B when properly located for charging. The position indicator module 162 senses connectivity between the tire 30 and the pads 118A-118C. As the vehicle advances into position, the tire 30 first contacts the rearward charging pad 118A, and the module 162 may send a signal to an associated display 164 for signaling a user operating the vehicle that the vehicle should be driven farther forward to position the tire 30 in the proper charging location. As will be appreciated, the display 164 may be positioned on a dashboard inside the vehicle or outside the vehicle cab in a location where a user operating the vehicle can view the display. Written instructions and/or graphical illustrations may be output on the display 164 for viewing. For example, when the tire 30 first contacts the rearward charging pad 118A as shown in FIG. 4A, the module 162 could display, “move forward slowly”. As the tire advances to a position in which it simultaneously contacts the rearward charging pad 118A and the central charging pad 118B as shown in FIG. 4B, the module 162 could display, “nearing position”. When the tire 30 reaches the predetermined charging position, in which the tire contacts all three charging pads 118A-118C as shown in FIG. 4C, the module could display, “STOP!” If the user overshoots the charging position so the tire 30 only contacts the central charging pad 118B and the forward charging pad 118C, the module 162 might display, “reverse slowly”, or if the tire only contacts the forward charging pad 118C, the module might display, “backup and try again”. Thus, the addition of the forward and rearward changing pads provides location information allowing the module 162 to determine the position status. As the charging system 110 automatically recharges the vehicle battery when the tires 30, 32 of the vehicle 34 are docked in contact with the pads, drivers do not need to take any further action to recharge the vehicle battery. It is envisioned that logic could be included in a vehicle docking routine similar to currently available parking routines to receive signals from the module 162 to automatically dock the vehicle in the proper location.

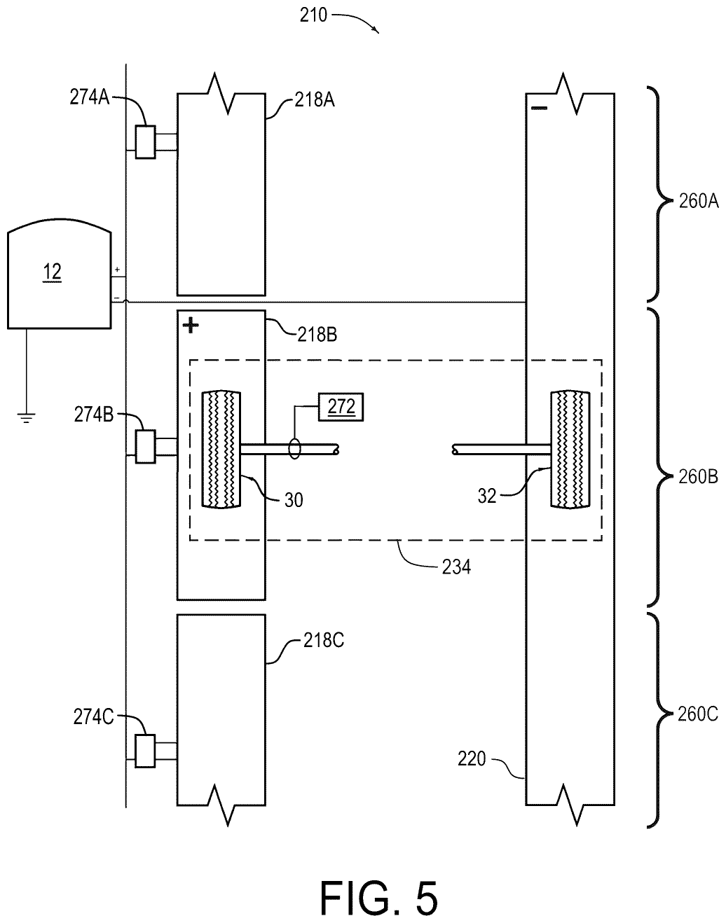

FIG. 5 shows a third example of a charging system, generally designated by 210, that is a “moving mode” system intended to charge a specially fitted electric vehicle 234 on a roadway comprising selectively energized roadway segments 270A-270C. It should be understood that the electric vehicle 234 of the third example includes additional features such as the recharging the battery pack 36, the battery management system 38, and the electrical conductors 44. These elements are omitted from FIG. 5 to reduce drawing complexity. Further, the addition of a “2” in the hundreds place of some elements (e.g., vehicle 234) indicates the element is structurally different from the corresponding element (e.g., vehicle 34) in the first example. The electric vehicle 234 includes a signal generator 272 that produces a unique digital signal or “squawk” signal. The signal generator 272 of the illustrated example is configured to produce a low-voltage, low frequency, digitally encrypted squawk signal. The illustrated vehicle 234 delivers the squawk signal to its driver-side electrically conductive tire 30. In other examples, the squawk signal may be delivered to the passenger side tire 32 or to both tires. The illustrated roadway segments 270A-270C are constructed of concrete having electrically conductive charging strips 218A-218C, 220 configured to receive the vehicle tires 30, 32. Rather than being constructed of metal, it is envisioned that the charging strips 218A-218C, 220 could be constructed of electrically conductive concrete, electrically conductive asphalt, electrically conductive rubber, or material combinations similar to the conductive tires. The conductive pad could be rolled out covering the road and designed such that it is electrically insulated from the conventional surface and still electrically connected to carry a charging current. The laterally spaced strips 218A-218C, 220 are electrically isolated so driver-side strips 218A-218C can carry a positive charge while the passenger-side strip 220 carry a negative charge. As shown in FIG. 5, the passenger-side strip 220 is connected to the negative terminal of the power supply 12, and each driver-side strip 218A-218C is operatively connected to the positive terminal of the power supply via a corresponding control module 274A-274C. As will be appreciated, the control modules 274A-274C only receive the squawk signal from the corresponding driver-side strip 218A-218C when the tire 30 of the specially equipped vehicle 234 contacts the strip. In response to receiving a squawk signal, the control module (e.g., module 274B) allows the full charging current to pass from the positive terminal of the power supply 12 to only energize the corresponding driver-side strip (e.g., strip 218B). Thus, the roadway segments 270A-270C are only energized when a specially equipped vehicle 234 is detected. As shown, when control modules (i.e., 274A and 274C) are not receiving a squawk signal, the corresponding charging strips (i.e., 218A and 218C) are not energized. Selectively energizing the strips reduces the opportunity for users, pedestrians, animals, or conductive elements to contact an energized strip. As the charging system 210 automatically recharges the vehicle battery when the tires 30, 32 of the specially equipped vehicle 234 contact the charging strips (e.g., 218B, 220), drivers do not need to take any action to recharge the vehicle battery. Because each signal generator 272 generates a unique code, the vehicle 234 is identifiable and its owner may be separately billed for electricity usage via a cyber secure debit transaction communicated to the charger without driver intervention. In an alternative example, the charging system of the third example may be implemented at stop lights so charging occurs when vehicles are stopped rather than on open roadways. In some examples, the passenger-side strip 220 may be at electrical ground potential. A ground fault interruption circuit could be used to shut down power should a ground fault occur. Excessive regenerative braking, for example, could cause a ground fault. In certain situations, it is envisioned that excess power could be returned to the grid.

It should be understood that the squawk circuit components of the third example may be incorporated in the systems of the first and second examples as additional alternatives so the electric vehicle 34 of those examples can be charged in moving mode similarly to the third example. Further, the squawk circuit may be incorporated in the first and second examples to prevent the charging circuits from being energized unless a vehicle capable of sending a squawk signal is connected to those charging circuits. Such alternatives would reduce the potential for people, animals, or conductive elements from contacting energized systems. In addition, employing the squawk circuit technology in the first and second examples, reduces the likelihood that the charging pads will be energized inadvertently or by tampering or by hacking. In cases where the charger is accessible to the public, the squawk circuit allows users to be charged by secure debit transaction using the unique code. In other cases, the system may be configured to only energize the charging pads after receiving a squawk signal from the vehicle and user entered debit information is approved. In cases where the charger is installed in a private residence, it is envisioned that the system will not be configured to perform a debit transaction but may require the user to turn the system on by way of a phone application, a wall mounted interface, or an interface located on the vehicle dashboard in addition to receiving a squawk signal from the vehicle. The system 210 may include ground fault interruption to prevent the system from being energized when a ground fault exists. In another alternative, the system could be configured to return power (e.g., excess power from regenerative braking) to the grid.

In addition to the safety features described previously, the systems 10, 110, 210 may include other features intended to improve system safety. For example, electric vehicles could be fitted with color coded lights (e.g., in wheel wells) and/or an auditory alert producing a sound (e.g., a hum or a tone) to alert persons that the charging pads or strips are energized. Further, the vehicle may include nonconductive fender skirts or nonconductive lighted wheel covers extending outside the tires to physically block tire contact. Ground fault interruption circuits and tire pressure and/or temperature interruption circuits are envisioned. Further, moisture, polarity, explosive gas sensors, and interruption circuits could be added.

As will be appreciated, the charging systems 10, 110, 210 described above eliminate a need for vehicle charging ports. Further, the charging systems 10, 110, 210 eliminate charging cables and connectors, as well as any potential for vandals to damage these components.

One of the limitations of fast charging direct current systems is that these systems require users to move heavy and stiff cables. These heavy cables sometimes require liquid cooling or special cooling materials making the process of present day fast direct current charging increasingly undesirable. The systems described above eliminate the need to handle heavy cables. Another limiting factor in fast charging is heat generation. The proposed charging systems described herein allow heat generated by the system to be transferred to the thermal mass of earth under the system. Much of the heat generated between the tires and charger is transferred to the earth. It is envisioned that “moving mode” systems could leverage some of this waste heat to enhance traction between the tires and charging pads in freezing weather conditions.

Moreover, it is envisioned that the system may include a smart phone application or vehicle dash system for informing users of a loss of grid power and the amount of battery charge remaining is envisioned.

As will be appreciated, the systems described may be powered by decentralized power grids and electrical storage systems. Centralized electrical grid blackouts and brownouts are avoidable by using smaller decentralized power grids and electrical storage techniques such as utility-grade electrochemical batteries and super capacitors, as well as mechanical energy storage using pumped storage hydroelectricity, compressed-air energy storage, flywheel energy storage, or lifted weight energy storage. These decentralized grids could be powered by off-peak electrical grid energy and/or renewable energy including onsite solar and onsite wind power. As should be appreciated, decentralized mini grids could be physically located near a public charger.

Another advantage of the “moving mode” system is that user range anxiety may be reduced, particularly if “moving mode” chargers are available frequently during travel. Further, readily available “moving mode” systems could reduce vehicle range requirements, thereby reducing battery size requirements. Smaller vehicle batteries result in lower vehicle weight which can reduce tire wear. Reduced vehicle battery size also allows for more space to be used for passenger compartments. Still further, reducing battery sizes may reduce raw material needs.

When introducing elements in this description and the claims, the articles “a”, “an”, “the”, and “said” are intended to indicate one or more of the elements. The terms “comprising”, “including”, and “having” are intended to be inclusive and indicate there may be additional elements other than the listed elements.

As those skilled in the art could make various changes to the above constructions, products, and methods without departing from the intended scope of the description, all matter in the above description and accompanying drawings should be interpreted as illustrative and not in a limiting sense. The patentable scope of the disclosure is defined by the claims, and can include other constructions and methods that would occur to those skilled in the art. Such other constructions are intended to be within the scope of the claims if the structural elements of the constructions do not differ from the literal language of the claims, or if the constructions include equivalent structural elements having insubstantial differences from the literal languages of the claims.

To the extent that the specification, including the claims and accompanying drawings, discloses any additional subject matter that is not within the scope of the claims below, the disclosures are not dedicated to the public and the right to file one or more applications to claims such additional disclosures is reserved.

1. An electric vehicle charging system for use an electric vehicle having a frame mounted on a plurality of wheels at least one wheel of said plurality of wheels being driven by an electrical motor mounted on the frame powered by a rechargeable battery mounted on the frame, and a charging system including two spaced wheels of said plurality of wheels capable of conducting electricity to the rechargeable battery for charging, said vehicle charging system comprising:
a selectively operable managed DC power supply having a first terminal and a second terminal, wherein said first terminal has a positive electrical charge relative to said second terminal when the managed DC power supply is operated;
an electrically insulating base sized to support the two spaced wheels simultaneously;
a plurality of electrically conductive charging pads mounted on said electrically insulating base, a first electrically conductive charging pad of said plurality of electrically conductive charging pads is electrically connected to the first terminal of the managed DC power supply and a second electrically conductive charging pad of said plurality of electrically conductive charging pads is electrically connected to the second terminal of the managed DC power supply, and said first electrically conductive charging pad and said second electrically conductive charging pad are positioned on the electrically insulating base to allow a first wheel of said two spaced wheels to be in electrical communication with the first electrically conductive charging pad while a second wheel of said two spaced wheels is in electrical communication with the second electrically conductive charging pad, thereby simultaneously electrically coupling the first terminal of the managed DC power supply to the rechargeable battery via the first electrically conductive charging pad and the first wheel of said two spaced wheels and the second terminal of the managed DC power supply to the rechargeable battery via the second electrically conductive charging pad and the second wheel of said two spaced wheels to charge the rechargeable battery in the electric vehicle.

2. An electric vehicle charging system as set forth in claim 1, wherein the managed DC power supply is configured to deliver DC power having a voltage less than 40 volts to said plurality of conductive charging pads.

3. An electric vehicle charging system as set forth in claim 1, wherein said plurality of conductive charging pads comprises a metal.

4. An electric vehicle charging system as set forth in claim 3, wherein said plurality of conductive charging pads comprises a combination of a metal and other materials.

5. An electric vehicle charging system as set forth in claim 1, further comprising:
a conductor positioned adjacent to the first electrically conductive charging pad; and
a position indicator module operatively connected between the first electrically conductive charging pad and the conductor, said module providing a signal when the first wheel of said two spaced wheels electrically connects the conductor and the first electrically conductive charging pad.

6. An electric vehicle charging system as set forth in claim 5, wherein:
said conductor is a first conductor;
the electric vehicle charging system further comprises a second conductor positioned adjacent to the first electrically conductive charging pad opposite said first conductor;
said signal provided by the module when said first wheel electrically connects said first conductor and the first electrically conductive charging pad is a first signal; and
the position indicator module is operatively connected between the first electrically conductive charging pad and said second conductor, said module providing a second signal distinguishable from the first signal when the first wheel of said two spaced wheels electrically connects the second conductor and the first electrically conductive charging pad.

7. An electric vehicle charging system as set forth in claim 1, further comprising a control module electrically connected to the first electrically conductive charging pad, said module being configured to fully energize said first electrically conductor charging pad when receiving a squawk signal generated by the electric vehicle.

8. An electric vehicle charging system as set forth in claim 1 in combination with said electric vehicle.

9. An electric vehicle charging system as set forth in claim 8 wherein said first wheel of said two spaced wheels is mounted on a drive side of the electric vehicle.

10. An electric vehicle for use with a charging system adapted to deliver DC power to spaced charging pads, said vehicle comprising:
a vehicle frame;
a rechargeable battery mounted on the vehicle frame;
an electric motor mounted on the vehicle frame and operatively connected to the rechargeable battery to power the electric motor;
a plurality of wheels rotatably mounted on the vehicle frame, at least one wheel of said plurality of wheels being operatively connected to the electric motor for rotating said wheel to move the electric vehicle, and at least two wheels of said plurality of wheels being in electrical communication with the rechargeable battery, wherein a first wheel of said two wheels is positionable on a first charging pad of said charging system while a second wheel of said plurality of wheels is positioned on a second charging pad of said charging system.

11. An electric vehicle as set forth in claim 10, wherein:
said first wheel of said two wheels comprises a first electrically conductive tire mounted on a first electrically conductive rim; and
said second wheel of said two wheels comprises a second electrically conductive tire mounted on a second electrically conductive rim.

12. An electric vehicle as set forth in claim 11, wherein said first and second electrically conductive tires each comprise:
opposing flexible electrically insulated sidewalls configured to sealingly fit on said first electrically conductive rim;
an annular electrically conductive tread bridging the flexible electrically insulated sidewalls; and
an electrically conductive liner positioned between the flexible electrically insulated sidewalls and extending between the electrically conductive tread and the rim allowing an electrical current to pass from a corresponding charging pad through the electrically conductive liner to the rim.

13. An electric vehicle as set forth in claim 12, wherein:
said first electrically conductive wheel further comprises a first rim on which said first electrically conductive tire is mounted; and
said second electrically conductive wheel further comprises a second rim on which said second electrically conductive tire is mounted.

14. An electric vehicle as set forth in claim 13, wherein:
said first electrically conductive wheel further comprises a first electrically conductive seal electrically connecting said first electrically conductive tire to said first rim; and
said second electrically conductive wheel further comprises a second electrically conductive seal electrically connecting said second electrically conductive tire to said second rim.

15. An electric vehicle as set forth in claim 13, wherein:
said first electrically conductive wheel further comprises a first electrically insulating cover mounted on the first rim; and
said second electrically conductive wheel further comprises a second electrically insulating cover mounted on the second rim.

16. An electric vehicle as set forth in claim 12, wherein each annular electrically conductive tread is formed from a combination of conductive materials, each conductive material being selected from a group of conductive materials consisting of conductive metal wires, metal braids, metal fabric, metal particles, metal powders, metal flakes, conductive elastomers, conductive polymers, carbon black, nanocarbon, nanotubes, silicone and carbon mixtures, graphite, graphene, silicone infused with silver or aluminum alloys, and nanocarbon black.

17. An electric vehicle as set forth in claim 13, wherein said first wheel of said two wheels is electrically insulated from said second wheel of said two wheels.
